(19) United States
(12) Patent Application Publication
(10) Pub. No.: US 2025/0149620 A1
(43) Pub. Date: May 8, 2025

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta Takasu, Nagoya-shi (JP); Atsushi Yamanaka, Nagoya-shi (JP); Masato Ono, Nagoya-shi (JP); Satoshi Moriyama, Nagoya-shi (JP); Kosuke Suzuki, Toyota-shi (JP); Kazuki Sugie, Miyoshi-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 18/921,465

(22) Filed: Oct. 21, 2024

(30) Foreign Application Priority Data
Nov. 2, 2023 (JP) 2023-188445

(51) Int. Cl. H01M 10/04; H01M 50/107

(52) U.S. Cl. CPC H01M 10/0431; H01M 50/107

(57) ABSTRACT

A power storage cell includes: an electrode body in which a sheet member is wound so as to surround a winding axis; and a case in which the electrode body is housed, in which: the sheet member includes an electrode sheet and a separator; the electrode sheet includes a current collector plate and an electrode composite material layer fabricated on the current collector plate; the electrode sheet includes a groove portion extending in a direction of the winding axis, in which the electrode composite material layer is not fabricated; a plurality of the groove portions is fabricated in a direction in which the electrode sheet extends; and an interval between the groove portions on a winding inner side is smaller than an interval between the groove portions on a winding outer side.

### CROSS-REFERENCE TO RELATED APPLICATION

This application claims priority to Japanese Patent Application No. 2023-188445 filed on Nov. 2, 2023. The disclosure of the above-identified application, including the specification, drawings, and claims, is incorporated by reference herein in its entirety.

### BACKGROUND

### 1. Technical Field

The present disclosure relates to a power storage cell.

### 2. Description of Related Art

Japanese Unexamined Patent Application Publication No. 2001-6749 (JP 2001-6749 A) discloses a lithium secondary battery including a winding-type internal electrode body in which a cathode metal foil body and an anode metal foil body are configured such that a separator is interposed. The internal electrode body is fabricated such that a cathode sheet, a separator and an anode sheet are wound.

### SUMMARY

The electrode body of the lithium secondary battery configured as described above is fabricated such that each sheet is wound.

For example, on a winding center side of the electrode body, the winding radius is small. As a result, on the winding center side, the winding radius of a cathode composite material layer of a cathode sheet is also small, and therefore, the cathode composite material layer is peeled, or a crack is generated in the cathode composite material layer. The same problem arises for an anode composite material layer of an anode sheet.

The present disclosure has been made in view of the above problem, and an object of the present disclosure is to provide a power storage cell that restrains a crack or the like from being generated in an electrode composite material layer.
[1] A power storage cell comprising:
an electrode body in which a sheet member is wound so as to surround a winding axis; and
a case in which the electrode body is housed, wherein: the sheet member includes an electrode sheet and a separator;
the electrode sheet includes a current collector plate and an electrode composite material layer fabricated on the current collector plate;
the electrode sheet includes a groove portion extending in a direction of the winding axis, in which the electrode composite material layer is not fabricated;
a plurality of the groove portions is fabricated in a direction in which the electrode sheet extends; and
an interval between the groove portions on a winding inner side is smaller than an interval between the groove portions on a winding outer side.
[2] The power storage cell according to [1], wherein: the electrode body includes a starting end portion of a wound body of the electrode body, and an ending end portion of the wound body of the electrode body; and intervals between the groove portions become greater from the starting end portion toward the ending end portion.
[3] The power storage cell according to [1] or [2], wherein a groove width of the groove portions on the winding inner side is smaller than a groove width of the groove portion on the winding outer side.
[4] The power storage cell according to any one of [1] to [3], wherein: the electrode sheet includes a cathode sheet and an anode sheet;
the cathode sheet includes a cathode current collector plate and a cathode composite material layer fabricated on the cathode current collector plate;
the cathode sheet includes a cathode groove portion extending in the direction of the winding axis, in which the cathode composite material layer is not fabricated;
the anode sheet includes an anode current collector plate and an anode composite material layer fabricated on the anode current collector plate;
the anode sheet includes an anode groove portion extending in the direction of the winding axis, in which the anode composite material layer is not fabricated; and
the cathode groove portion and the anode groove portion are fabricated so as to face each other.
[5] The power storage cell according to [4], wherein a groove width of the anode groove portion is smaller than a groove width of the cathode groove portion.

With the power storage cell according to the present disclosure, it is possible to restrain a crack or the like from being generated in an electrode composite material layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a power storage cell 1 according to an embodiment;

FIG. 2 is a perspective view schematically showing an electrode body 10;

FIG. 3 is a plan view showing a cathode sheet 22;

FIG. 4 is a plan view showing an anode sheet 24;

FIG. 5 is an expansion plan view showing a state where a sheet member 20 is expanded and where sheets are arrayed; and

FIG. 6 is a sectional view showing the cathode sheet 22, the anode sheet 24, a separator 21, and a separator 23 in FIG. 5.

### DETAILED DESCRIPTION OF EMBODIMENTS

An embodiment of the present disclosure will be described below in detail with reference to the drawings. In the drawings, identical or corresponding portions are denoted by identical reference characters, and descriptions thereof are not repeated.

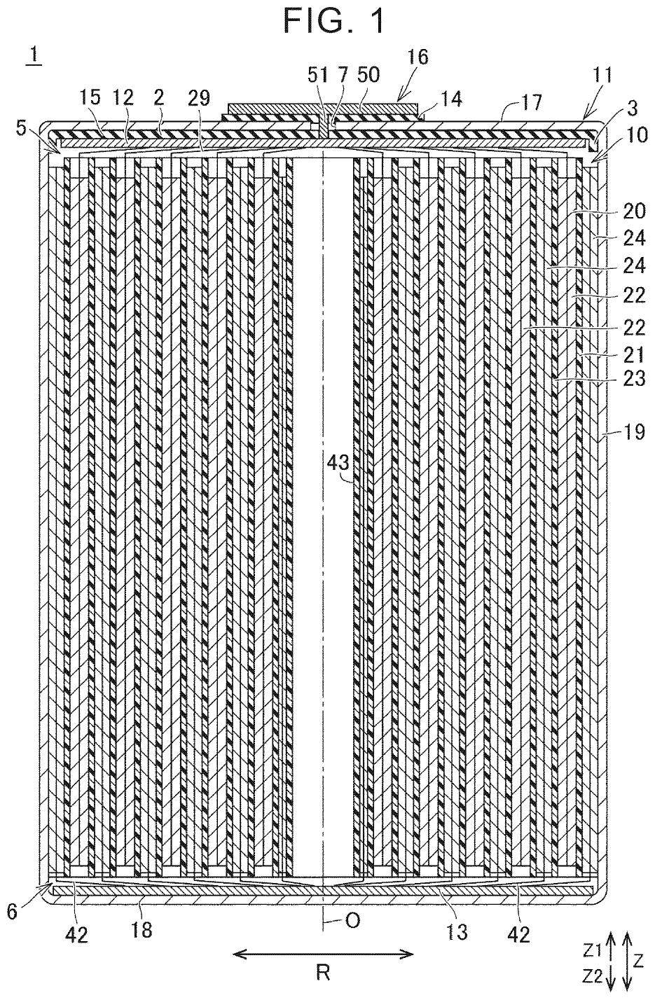

FIG. 1 is a sectional view showing a power storage cell 1 according to the embodiment. The power storage cell 1 includes a cylindrical electrode body 10 that is fabricated so as to surround a winding axis O, a case 11, a cathode current collector member 12, an anode current collector member 13, insulating members 14, 15, and a cathode terminal 16.

In FIG. 1 and others, “Z” denotes a direction in which the winding axis O extends. “Z1” denotes one direction of the Z-direction. “Z2” denotes the other direction of the Z-direction. “R” denotes a radial direction of the electrode body 10.

The case 11 includes a top plate 17, a bottom plate 18, and a circumferential wall 19. The case 11 is formed of a metal material. The top plate 17 is positioned at one end of the case 11, and the bottom plate 18 is positioned at the other end of the case 11. The circumferential wall 19 is disposed between the top plate 17 and the bottom plate 18.

A through-hole 7 is formed in the top plate 17. The insulating member 14 is disposed on an outer surface of the top plate 17, and a through-hole is formed in the insulating member 14.

The insulating member 15 includes a top plate portion 2 and a circumferential wall 3 that is provided at an outer circumferential edge portion of the top plate portion 2. The top plate portion 2 is disposed on an inner surface of the top plate 17. The circumferential wall 3 is disposed on an inner circumferential surface of the circumferential wall 19. A through-hole is formed in the top plate 17.

The cathode terminal 16 includes a flat plate 50 and a shaft 51. The flat plate 50 is disposed on the insulating member 14. The shaft 51 is connected to the flat plate 50, and is fabricated so as to extend in the Z2-direction. The shaft 51 is inserted into the case 11 through the through-hole 7 formed in the insulating member 14 and a through-hole formed in the insulating member 15.

The cathode current collector member 12 is disposed on a Z2-directional side of the insulating member 15. The cathode current collector member 12 has a plate shape, and a lower end portion of the shaft 51 is welded to an upper surface of the cathode current collector member 12. For example, the cathode current collector member 12 is formed of aluminum or the like.

The anode current collector member 13 is disposed on an inner surface of the bottom plate 18. The anode current collector member 13 has a plate shape, and is formed of a metal material such as copper.

The electrode body 10 is disposed between the cathode current collector member 12 and the anode current collector member 13 in the case 11.

The electrode body 10 includes a first end portion 5 that is positioned on a Z1-directional side, and the cathode current collector member 12 is disposed on the first end portion 5. The electrode body 10 includes a second end portion 6 that is positioned on a Z2-directional side, and the anode current collector member 13 is disposed on the second end portion 6. The electrode body 10 has a hollow shape, and a hollow portion 43 is formed therein. The hollow portion 43 is formed at a position that passes through the winding axis O.

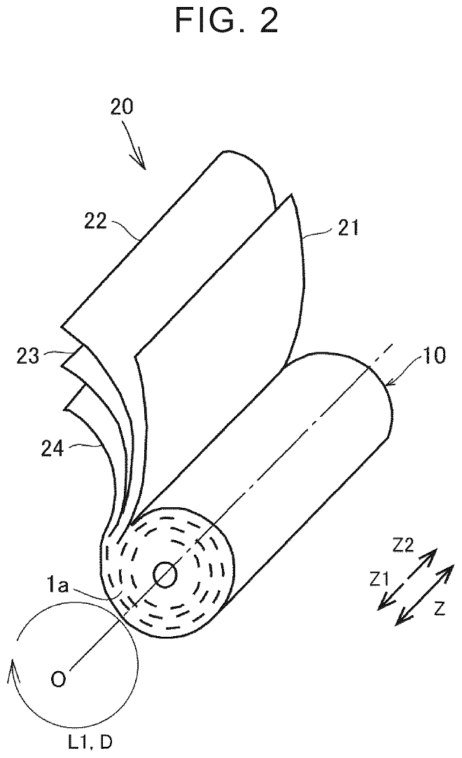

FIG. 2 is a perspective view schematically showing the electrode body 10. The electrode body 10 includes a sheet member 20 that is fabricated so as to surround the winding axis O. “D” denotes a direction in which the sheet member 20 extends in the electrode body 10 in a wound state.

The sheet member 20 is fabricated so as to be long in the winding direction D of the electrode body 10. The sheet member 20 includes a separator 21, a cathode sheet 22, a separator 23, and an anode sheet 24.

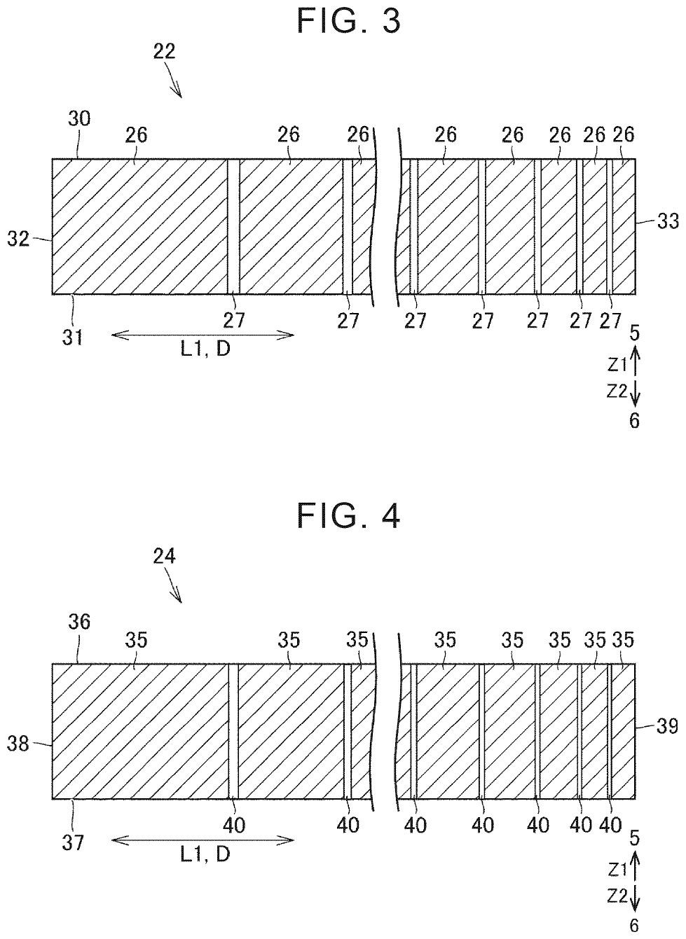

FIG. 3 is a plan view showing a cathode sheet 22. The cathode sheet 22 shown in FIG. 3 is in a state where the cathode sheet 22 is demounted and spread from a state of being wound into the electrode body 10. The cathode sheet 22 includes long sides 30, 31 and short sides 32, 33. The long sides 30, 31 extend in an LI-direction in which the cathode sheet 22 extends. The L1-direction corresponds to the winding direction D in the state of the wound electrode body 10. The long side 30 is positioned at the first end portion 5 of the electrode body 10 in the wound state, and the long side 31 is positioned at the second end portion 6 of the electrode body 10 in the wound state.

The cathode sheet 22 includes a cathode current collector plate 25 and a cathode composite material layer 26. For example, the cathode current collector plate 25 is formed of a metal material such as aluminum or an aluminum alloy.

The cathode composite material layer 26 contains a cathode active material, a binder, and others. Examples of the cathode active material include LiCoO₂, LiNo₂, and LiMn₂O₄. The thickness of the cathode composite material layer 26 is 0.1 μm or more and 1000 μm or less, for example.

The cathode composite material layer 26 may be fabricated on both of front and back surfaces of the cathode current collector plate 25, or may be fabricated on one surface. The cathode sheet 22 includes a cathode groove portion 27 that extends in the direction of the winding axis O and in which the cathode composite material layer 26 is not 30 fabricated. A plurality of cathode groove portions 27 is fabricated in the direction in which the cathode sheet 22 extends. The cathode composite material layer 26 is divided by the plurality of cathode groove portions 27. In the case where the cathode composite material layer 26 is fabricated on both of the front and back surfaces of the cathode current collector plate 25, the cathode groove portion 27 may be fabricated on both cathode composite material layers 26 on the front and back surfaces, or may be fabricated on one surface. In the case where the cathode groove portion 27 is fabricated on one surface, it is preferable that the one surface is fabricated on a side that becomes a winding outer side.

FIG. 4 is a plan view showing an anode sheet 24. The anode sheet 24 shown in FIG. 4 is in a state where the anode sheet 24 is demounted and spread from a state of being wound into the electrode body 10. The anode sheet 24 includes long sides 36, 37 and short sides 38, 39. The long sides 36, 37 extend in an L2-direction in which the anode sheet 24 extends. The L2-direction corresponds to the winding direction D in the state of the wound electrode body 10. The long side 36 is positioned at the first end portion 5 of the electrode body 10 in the wound state, and the long side 37 is positioned at the second end portion 6 of the electrode body 10 in the wound state.

The anode sheet 24 includes an anode current collector plate 34 and an anode composite material layer 35. For example, the anode current collector plate 34 contains a metal material such as copper.

The anode composite material layer 35 contains an anode active material, a binder, and others. Examples of the anode active material include graphite. The thickness of the anode composite material layer 35 is 0.1 μm or more and 1000 μm or less, for example.

The anode composite material layer 35 may be fabricated on both of front and back surfaces of the anode current collector plate 34, or may be fabricated on one surface. The anode sheet 24 includes an anode groove portion 40 that extends in the direction of the winding axis O and in which the anode composite material layer 35 is not fabricated. A plurality of anode groove portions 40 is fabricated in the direction in which the anode sheet 24 extends. The anode composite material layer 35 is divided by the plurality of anode groove portions 40. In the case where the anode composite material layer 35 is fabricated on both of the front and back surfaces of the anode current collector plate 34, the anode groove portion 40 may be fabricated on both anode composite material layers 35 on the front and back surfaces, or may be fabricated on one surface. In the case where the anode groove portion 40 is fabricated on one surface, it is preferable that the one surface is fabricated on a side that becomes a winding outer side.

In FIG. 1, the anode composite material layer 35 is fabricated such that the length of the anode composite material layer 35 is longer than the length of the cathode composite material layer 26 in the Z-direction.

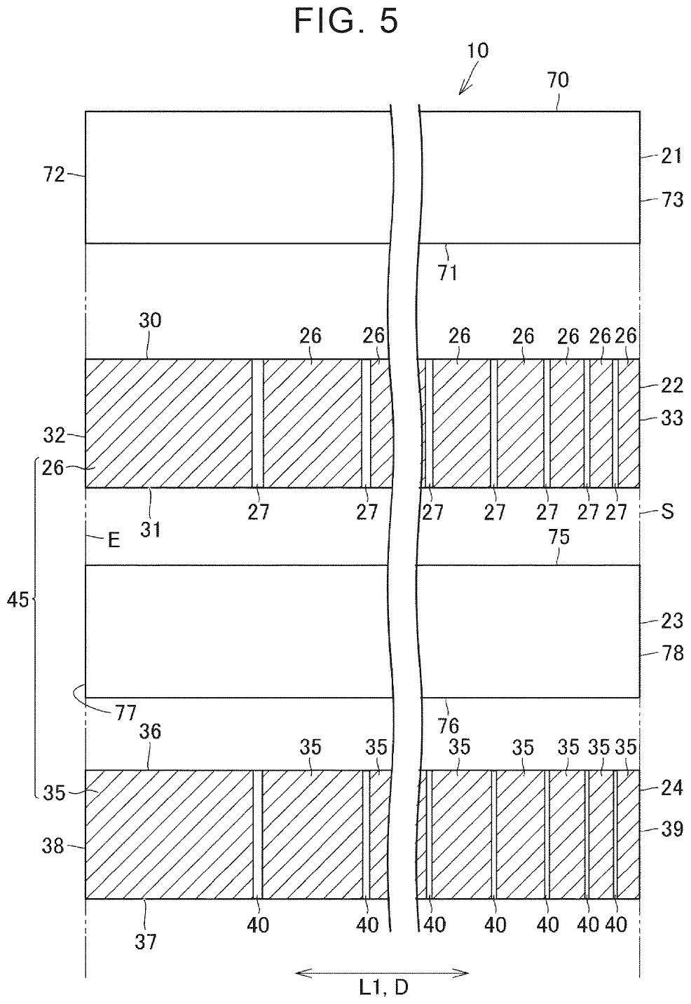

FIG. 5 is an expansion plan view showing a state where the sheet member 20 is expanded and where the sheets are arrayed. The sheet member 20 is fabricated by placing the separator 23 on the anode sheet 24, placing the cathode sheet 22 on the separator 23 and placing the separator 21 on the cathode sheet 22. The position of the anode sheet 24 and the position of the cathode sheet 22 may be exchanged.

The separator 21 and the separator 23 are fabricated so as to be elongated. The separator 21 includes long sides 70, 71 and short sides 72, 73. The separator 23 includes long sides 75, 76 and short sides 77, 78.

In FIG. 5, the electrode body 10 includes an electrode composite material layer 45, and the electrode composite material layer 45 includes the cathode composite material layer 26 and the anode composite material layer 35. The electrode body 10 includes a starting end portion S of a wound body of the electrode body 10 and an ending end portion E of the wound body of the electrode body 10.

In the example shown in FIG. 5, the short side 33 and the short side 39 are positioned at the starting end portion S. The short side 32 and the short side 38 are positioned at the ending end portion E. The short side 33 and the short side 39 may deviate from each other in the winding direction D. In this case, the starting end portion S is a side that is closer to the winding axis O in the wound state. Similarly, in the case where the short side 32 and the short side 38 deviate from each other in the winding direction D, the ending end portion E is a side that is more distant from the winding axis O. In the example shown in FIG. 5, the short sides 73, 78 of the separators 21, 23 are also positioned at the starting end portion S, and the short sides 72, 73 are also positioned at the ending end portion E. However, the separators 21, 23 may be fabricated so as to be longer in the winding direction D than the cathode sheet 22 and the anode sheet 24.

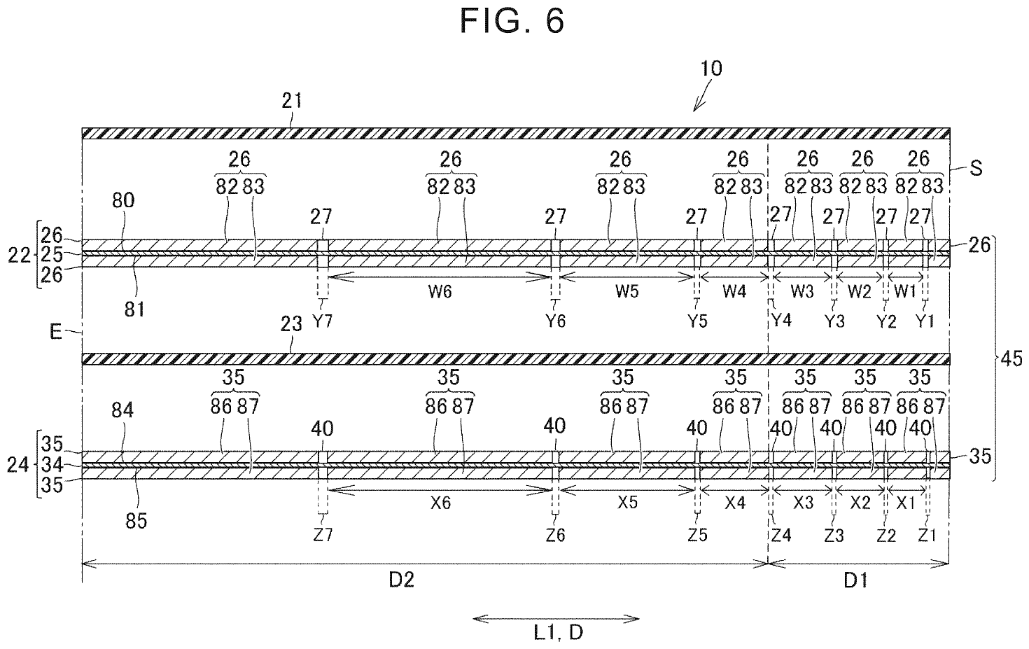

FIG. 6 is a sectional view showing the cathode sheet 22, the anode sheet 24, the separator 21, and the separator 23 in the FIG. 5. The cathode current collector plate 25 includes a main surface 80 and a main surface 81. The cathode composite material layers 26 include a one-side cathode composite material layer 82 fabricated on the main surface 80 and a one-side cathode composite material layer 83 fabricated on the main surface 81.

The anode current collector plate 34 includes a main surface 84 and a main surface 85. The anode composite material layers 35 includes a one-side anode composite material layer 86 fabricated on the main surface 84 and a one-side anode composite material layer 87 fabricated on the main surface 85.

In the example shown in FIG. 6, the starting end portion S on the winding inner side of the wound body is positioned on the right side, and the ending end portion E on the winding outer side of the wound body is position on the left side. Intervals among groove portions on the winding inner side that is the right side in FIG. 6 are smaller than intervals among groove portions on the winding outer side that is the left side in FIG. 6. In FIG. 6, the winding inner side is denoted by D1, and the winding outer side is denoted by D2. The winding inner side and the winding outer side are just examples, and are limited to this.

The electrode body 10 is fabricated so as to surround the winding axis O from the starting end portion S. Therefore, in the electrode body 10 in the wound state, the curvature on the winding inner side is higher than the curvature on the winding outer side, so that the bending stress on the winding inner side is higher.

Therefore, on the winding inner side, there is a fear that a crack is generated in the electrode composite material layer 45. However, in the power storage cell 1 according to the embodiment, the electrode sheet includes the plurality of groove portions in each of which the electrode composite material layer 45 is not fabricated. The intervals among the groove portions on the winding inner side are smaller than the intervals among the groove portions on the winding outer side. Therefore, a crack or the like is restrained from being generated in the electrode composite material layer 45.

In the cathode sheet 22 shown in FIG. 6, intervals W1, W2, W3 among the cathode groove portions 27 on the winding inner side are smaller than intervals W4, W5, W6 among the cathode groove portions 27 on the winding outer side. In the anode sheet 24, intervals X1, X2, X3 among the anode groove portions 40 on the winding inner side are smaller than intervals X4, X5, X6 among the anode groove portions 40 on the winding outer side.

It is preferable that the interval between groove portions become greater from the starting end portion S toward the ending end portion E. In the case where groove portions are provided on the electrode composite material layer 45, the amount of the active material contained in the electrode composite material layer 45 becomes small, and therefore, the capacity decreases. Therefore, the groove portions are not evenly on the electrode composite material layer 45, and a larger number of groove portions are provided on the winding inner side where the bending stress is high, so that the decrease in capacity is restrained.

In the cathode sheet 22 shown in FIG. 6, it is preferable that W1<W2<W3<W4<W5<W6 is satisfied, as the interval between the cathode groove portions 27. In the anode sheet 24, it is preferable that X1<X2<X3<X4<X5<X6 is satisfied, as the interval between the anode groove portions 40.

It is preferable that groove widths of the groove portions on the winding inner side are smaller than groove widths of the groove portions on the winding outer side. This is because it is possible to sufficiently restrain a crack or the like from being generated in the electrode composite material layer 45 on the winding inner side where the bending stress is high, even when the groove widths of the groove portions are small. Further, this is because it is possible to sufficiently secure the area of portions in which the electrode composite material layer 45 is fabricated, while the groove portions are provided.

In the cathode sheet 22 shown in FIG. 6, it is preferable that groove widths Y1, Y2, Y3, Y4 of the cathode groove portions 27 on the winding inner side are smaller than groove widths Y5, Y6, Y7 of the cathode groove portions 27 on the winding outer side. In the anode sheet 24, it is preferable that groove widths Z1, Z2, Z3, Z4 of the anode groove portions 40 on the winding inner side are smaller than groove widths Z5, Z6, Z7 of the anode groove portions 40 on the winding outer side.

It is preferable that the groove width of the groove portion becomes greater from the starting end portion S toward the ending end portion E. This is because the bending stress is higher at a portion closer to the starting end portion S.

In the cathode sheet 22 shown in FIG. 6, it is preferable that Y1<Y2<Y3<Y4<Y5<Y6<Y7 is satisfied, as the groove width of the cathode groove portion 27. In the anode sheet 24, it is preferable that Z1<Z2<Z3<74<Z5<Z6<Z7 is satisfied, as the groove width of the anode groove portion 40.

It is preferable that the cathode groove portions 27 and the anode groove portions 40 are fabricated so as to face each other. In the case where the anode groove portions 40 are provided on the anode sheet 24, there is a fear that the proportion of portions of the cathode sheet 22 that face anode groove portions 40 increases and lithium is deposited. Therefore, by causing the cathode groove portions 27 and the anode groove portions 40 to be fabricated so as to face each other, the proportion of portions of the cathode sheet 22 that face anode groove portions 40 is restrained, and thereby, the deposition of lithium can be restrained.

In this case, it is preferable that the groove width of the anode groove portion 40 is smaller than the groove width of the cathode groove portion 27 that is faced. Thereby, the deposition of lithium can be further restrained.

In FIG. 6, Y1>Z1 is preferable, Y2>Z2 is preferable, Y3>Z3 is preferable, Y4>Z4 is preferable, Y5>Z5 is preferable, Y6>Z6 is preferable, and Y7>Z7 is preferable.

10 It should be understood that the embodiment disclosed herein is an example and is not limitative in all respects. It is intended that the present disclosure is shown by the claims and all alterations within meanings and ranges equivalent to the claims are included.

What is claimed is:

1. A power storage cell comprising:
an electrode body in which a sheet member is wound so as to surround a winding axis; and
a case in which the electrode body is housed, wherein:
the sheet member includes an electrode sheet and a separator;
the electrode sheet includes a current collector plate and an electrode composite material layer fabricated on the current collector plate;
the electrode sheet includes a groove portion extending in a direction of the winding axis, in which the electrode composite material layer is not fabricated;
a plurality of the groove portions is fabricated in a direction in which the electrode sheet extends; and
an interval between the groove portions on a winding inner side is smaller than an interval between the groove portions on a winding outer side.

2. The power storage cell according to claim 1, wherein:
the electrode body includes a starting end portion of a wound body of the electrode body, and an ending end portion of the wound body of the electrode body; and
intervals between the groove portions become greater from the starting end portion toward the ending end portion.

3. The power storage cell according to claim 1, wherein a groove width of the groove portions on the winding inner side is smaller than a groove width of the groove portion on the winding outer side.

4. The power storage cell according to claim 1, wherein:
the electrode sheet includes a cathode sheet and an anode sheet;
the cathode sheet includes a cathode current collector plate and a cathode composite material layer fabricated on the cathode current collector plate;
the cathode sheet includes a cathode groove portion extending in the direction of the winding axis, in which the cathode composite material layer is not fabricated;
the anode sheet includes an anode current collector plate and an anode composite material layer fabricated on the anode current collector plate;
the anode sheet includes an anode groove portion extending in the direction of the winding axis, in which the anode composite material layer is not fabricated; and
the cathode groove portion and the anode groove portion are fabricated so as to face each other.

5. The power storage cell according to claim 4, wherein a groove width of the anode groove portion is smaller than a groove width of the cathode groove portion that is faced.
